(19) United States
(12) Patent Application Publication
(10) Pub. No.: US 2010/0066682 A1
(43) Pub. Date: Mar. 18, 2010

(54) ELECTRONIC DEVICE WITH A TOUCH PANEL

(76) Inventors: Chi-Ming TSENG, Tu-Cheng City (TW); Hsueh-Yu Lu, Tu-Cheng City (TW)

Correspondence Address: Muncy, Geissler, Olds & Lowe, PLLC, P.O. BOX 1364, FAIRFAX, VA, 22038-1364, US

(21) Appl. No.: 12/212,237

(22) Filed: Sep. 17, 2008

(51) Int. Cl. G06F 3/041

(52) U.S. Cl. 345/173

(57) ABSTRACT

An electronic device with a touch panel has an insulating housing, a display module mounted on the insulating housing, a touch panel and a shell. The touch panel fixed on the display module has a fixing plate and a touch portion fixed on the fixing plate. The fixing plate is positioned to the display module by means of an engagement of a protruding portion and a cavity between the fixing plate and the display module. The shell engaged with the insulating housing defines a receiving opening for exposing the touch portion.

### BACKGROUND OF THE INVENTION

1. Field of the Invention

This present invention relates to an electronic device, and more specifically to an electronic device with a touch panel.

2. The Related Art

Conventionally, an electronic device with a touch panel has an insulating housing, a display module mounted on the insulating housing, a touch panel fixed on the display module and a shell mated with the insulating housing. The touch panel includes a fixing plate and a touch portion fixed on the fixing plate. The shell defines an opening corresponding to the touch portion for exposing the touch portion. In assembly, the fixing plate of the touch panel is positioned on the display module via an accessorial tool. The accessorial tool is easy to bring or produce powder during assembling process. As a result, the electronic device is polluted so as to affect quality thereof. Furthermore, the accessorial tool requires some time to be manufactured and mounted on the display module, which will add manufacture time and manufacture cost of the electronic device.

### SUMMARY OF THE INVENTION

An object of the invention is to provide an electronic device with a touch panel having a structure which can reduces manufacture time and manufacture cost of the electronic device without affecting quality of the electronic device. The electronic device with a touch panel has an insulating housing, a display module mounted on the insulating housing, a touch panel and a shell. The touch panel fixed on the display module has a fixing plate and a touch portion fixed on the fixing plate. The fixing plate is positioned to the display module by means of an engagement of a protruding portion and a cavity between the fixing plate and the display module. The shell coupled with the insulating housing defines a receiving opening for exposing the touch portion.

As described above, in process of assembling the electronic device with a touch panel, the touch panel is positioned exactly to the display module via the engagement of a protruding portion and a cavity between the fixing plate and the display module. Thus it does not need to manufacture accessorial tool for positioning the touch panel to the display module, which avoids bringing or producing powder in the assembling process of the electronic device with a touch panel, furthermore, reduces manufacture cost and time of the electronic device with a touch panel.

### BRIEF DESCRIPTION OF THE DRAWINGS

The invention, together with its objects and the advantages thereof may be best understood by reference to the following description taken in conjunction with the accompanying drawings, in which:

FIG. 1 is an assembled, perspective view of an electronic device with a touch panel of an embodiment in accordance with the present invention;

FIG. 2 is an exploded view of the electronic device with a touch panel shown in FIG. 1;

FIG. 3 is a partly enlarged view showing an enlarged III portion of FIG. 2;

FIG. 4 is an assembled, perspective view of a touch panel of the electronic device with a touch panel shown in FIG. 2;

FIG. 5 is a partly enlarged view showing an enlarged V portion of FIG. 2;

FIG. 6 is an assembled, perspective view of a display module of the electronic device with a touch panel shown in FIG. 2;

FIG. 7 is an assembled, perspective view of the touch panel and the display module shown in FIG. 2;

FIG. 8 is a cross-sectional view taken along VIII-VIII of FIG. 7;

FIG. 9 is a partly enlarged view showing an enlarged IX portion of FIG. 2;

FIG. 10 is a perspective view of a shell shown in FIG. 2 while seen from another view; and

FIG. 11 is a cross-sectional view of the electronic device with a touch panel shown in FIG. 1.

### DETAILED DESCRIPTION OF THE EMBODIMENT

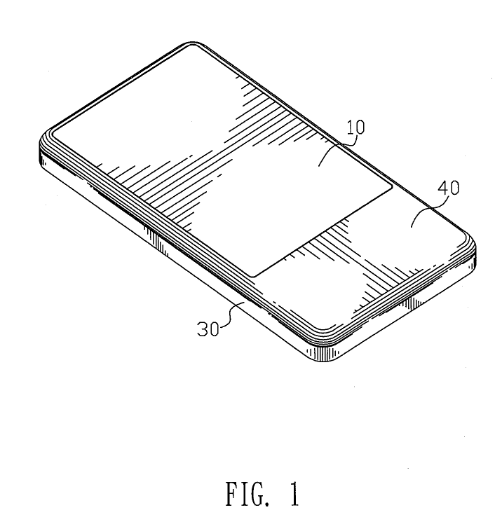

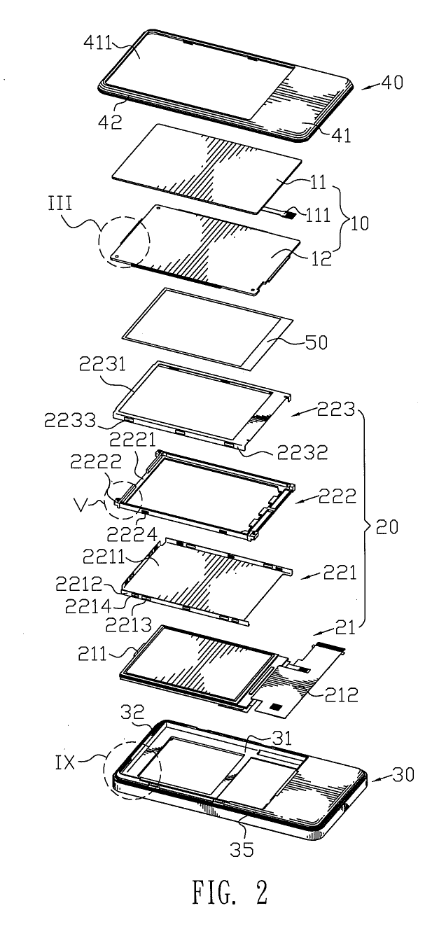

Referring to FIG. 1 and FIG. 2, an embodiment of an electronic device with a touch panel according to the present invention is shown. The electronic device with a touch panel includes a touch panel 10, a display module 20, an insulating housing 30 and a shell 40 engaged with the insulating housing 30.

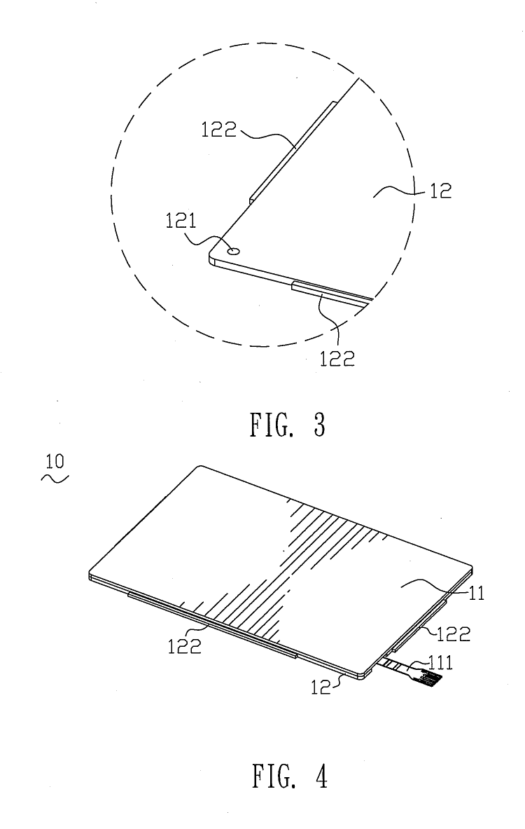

Referring to FIGS. 2-4, the touch panel 10 has a touch portion 11 and a fixing plate 12 disposed under the touch portion 11. The touch portion 11 is rectangular and has a first circuit board 111. The first circuit board 111 is flexible and disposed at a side of the touch portion 11. The touch portion 11 is stuck to the fixing plate 12. The fixing plate 12 is also rectangular and made of insulating material. In this embodiment, the fixing plate 12 is made of plastic material. The fixing plate 12 has a mating portion 121 at a corner thereof. The mating portion 121 may be a protrusion shape or a cavity shape. In this embodiment, three corners of the fixing plate 12 respectively have the mating portion 121, and the mating portion 121 passes through the fixing plate 12 to show the cavity shape. Each edge of the fixing plate 12 protrudes outwards to form a positioning protrusion 122. A double-side tape 50, which is a paper with glue at both surfaces thereof, is stuck to a bottom of the fixing plate 12 for fixing the touch panel 10 to the display module 20. It should be noted that the number of the mating portions 121 can be changed for conforming to different demands and should not be limited.

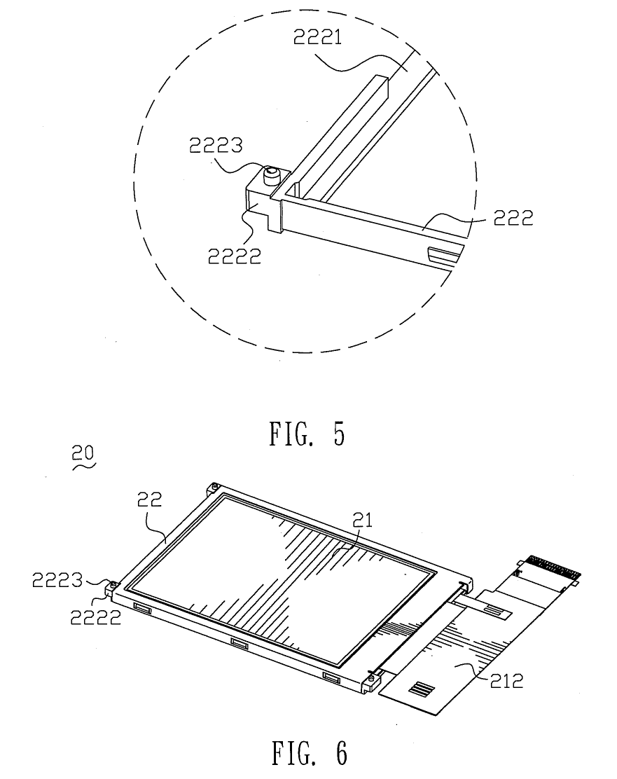

Referring to FIG. 2 and FIGS. 5-6, the display module 20 includes a display portion 21 and a fixing frame 22 adapted for fixing the display portion 21. The display portion 21 is substantially oblong. One end of the display portion 21 protrudes outwards to form a fixing projection 211, and the other end of the display portion 21 has a second circuit board 212. The second circuit board 212 is flexible and adapted for electrically connecting with the first circuit board 111.

The fixing frame 22 has a receiving shell 221, a first frame 222 and a second frame 223. The receiving shell 221 is rectangular and defines a basic plate 2211 and a plurality of sidewalls 2212 bending upwards from three edges of the basic plate 2211. Each of the sidewalls 2212 has a mating hole 2213 and a buckling projection 2214 adjacent to the mating hole 2213. The first frame 222 disposed on the receiving shell 221 for receiving the display portion 21 is made of insulating material. An end of the first frame 222 has a fixing recess 2221 for receiving the fixing projection 211. Both ends of the first frame 222 protrude outwards to form two protrusions 2222, respectively. The protrusions 2222 at the same end are arranged to be adjacent to two edges of the first frame 222, respectively. Each of the protrusions 2222 extends upwards to form a positioning portion 2223 corresponding to the mating portion 121 for positioning the touch panel 10. The edge of the first frame 222 has a mating projection 2224 corresponding to the mating hole 2213. The mating hole 2213 is coupled with the mating projection 2224 for fixing the first frame 222 and the receiving shell 221. The second frame 223 defines a top plate 2231 covering the display portion 21 and first frame 222, and two lateral plates 2232 bending downwards from two sides of the top plate 2231 for coupling with the receiving shell 221. The lateral plate 2232 has a plurality of buckling holes 2233 mating with the corresponding buckling projections 2214 for fixing the second frame 223 and the receiving shell 221.

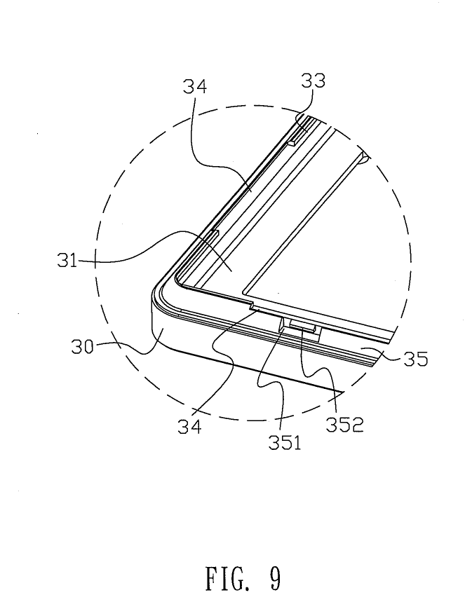

Referring to FIG. 2 and FIG. 9, the insulating housing 30 is rectangular and defines a receiving cavity 31 at a top thereof. The receiving cavity 31 is arranged at an end of the insulating housing 30 and enclosed by a stopping sidewall 32. The stopping sidewall 32 has a fixing recess 33 at an inner surface thereof and a positioning recess 34 corresponding to the positioning protrusion 122. The fixing recess 33 passes through a top surface of the stopping sidewall 32 for restraining the fixing plate 12. The insulating housing 30 defines an oblique mating surface 35 at an upper outer surface thereof. The oblique mating surface 35 is recessed downwards to form a buckling recess 351. A side of the buckling recess 351 adjacent to the receiving cavity 31 protrudes outwards to form a stopping projection 352. In this embodiment, there are four buckling recesses 351 arranged symmetrically on two opposite oblique mating surfaces 35.

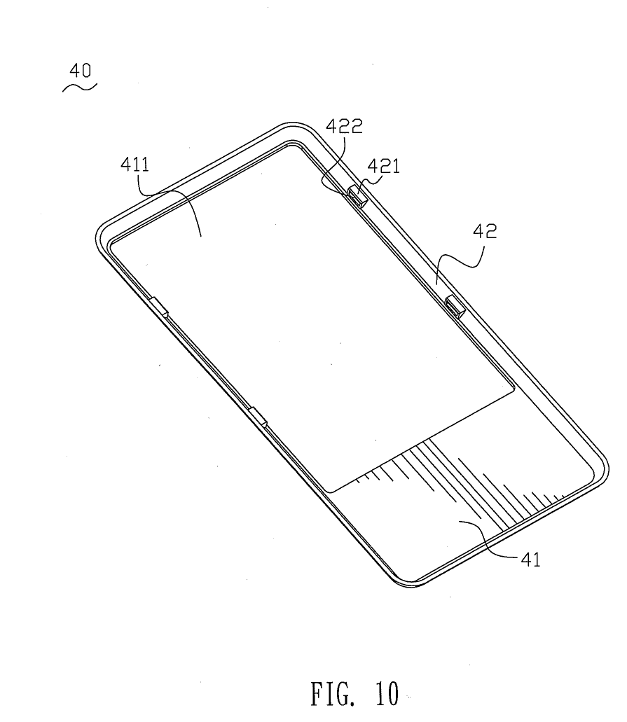

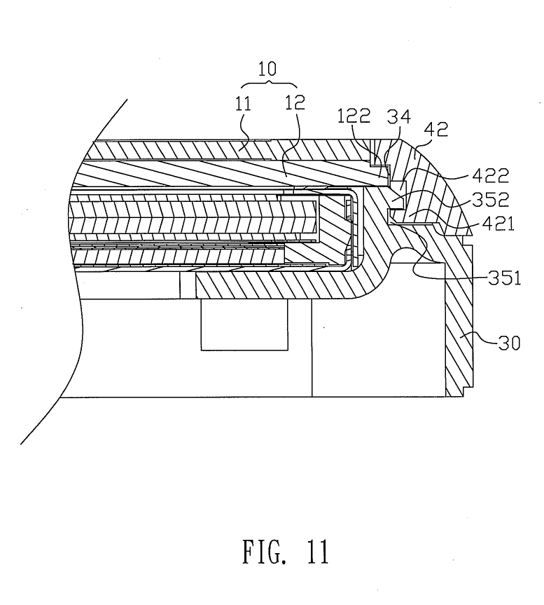

Referring to FIG. 2 and FIG. 10, the shell 40 engaged with the insulating housing 30 defines a covering plate 41 and a covering sidewall 42 bending downwards from an edge of the covering plate 41. The covering plate 41 has a receiving opening 411 capable of receiving the touch portion 11. An inner surface of the covering sidewall 42 extends inwards to form a buckling block 421 corresponding to the buckling recess 351. The buckling block 421 is recessed to form a stopping recess 422 corresponding to the stopping projection 352.

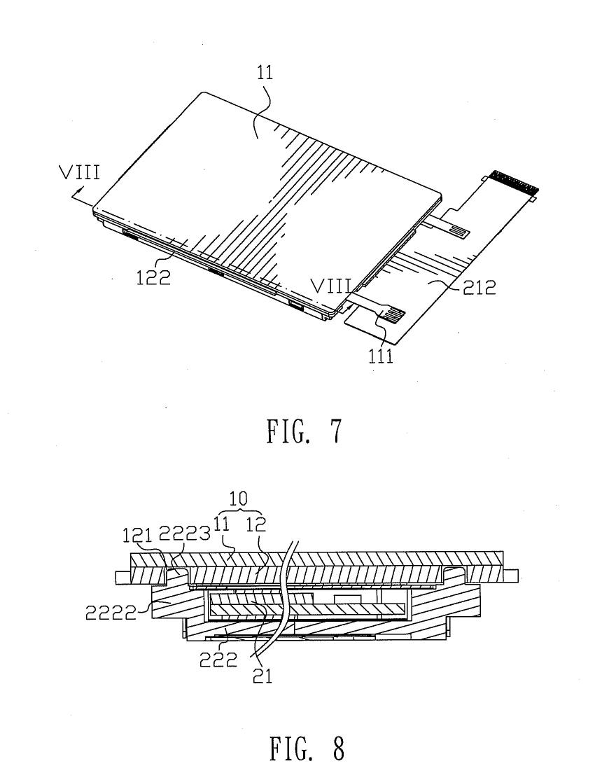

Referring to FIG. 4 and FIGS. 6-8, in assembly, the mating portion 121 of the touch panel 10 is engaged with the positioning portion 2223 of the display module 20 for positioning the touch panel 10 to the display module 20 exactly. The double-side tape 50 disposed between the touch panel 10 and the display module 20 is adapted for sticking the touch panel 10 and the display module 20 together, thus the touch panel 10 is fixed to the display module 20 firmly. The first circuit board 111 is soldered on the second circuit board 212 for electrically connecting the touch panel 10 and the display module 20.

Referring to FIG. 4 and FIGS. 9-11, the display module 20 with the touch panel 10 mounted thereon is disposed in the receiving cavity 31, the positioning protrusion 122 of the fixing portion 12 is disposed in the positioning recess 34, and an edge of the fixing plate 12 is received in the fixing recess 33. Thus touch panel 10 and the display module 20 are received in the insulating housing 30. The covering plate 41 of the shell 40 is partly against the positioning protrusion 122 of the fixing plate 12, and the touch portion 11 is received in the receiving opening 411. Thus a top surface of the touch portion 11 is flush with that of the covering plate 41, which is more convenient for a user to operate. The covering sidewall 42 is secured to the oblique mating surface 35 of the insulating housing 30. The buckling block 421 is inserted into the buckling recess 351, and the stopping projection 352 is inserted into the stopping recess 422. Thus the shell 40 is fixed to the insulating housing 30 firmly. Then the electronic device with a touch panel is assembled.

As described above, in process of assembling the electronic device with a touch panel, the touch panel 10 is positioned exactly to the display module 20 via the mating portion 122 engaged with the positioning portion 2223. Thus it does not need to manufacture accessorial tool for positioning the touch panel 10 to the display module 20, which avoids bringing or producing powder during the assembling process of the electronic device with a touch panel, furthermore, reduces manufacture cost and time of the electronic device without affecting quality thereof.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. An electronic device with a touch panel, comprising:
an insulating housing;
a display module mounted on the insulating housing;
a touch panel mounted on the display module, the touch panel having a fixing plate and a touch portion fixed on the fixing plate; and
a shell engaged with the insulating housing and defining a receiving opening for exposing the touch portion,
wherein the fixing plate is positioned to the display module by means of an engagement of a protruding portion and a cavity between the fixing plate and the display module.

2. The electronic device with a touch panel as set forth in claim 1, wherein the display module has a fixing frame, a corner of the fixing frame extends outwards to form a protrusion with a positioning portion formed thereon, and the display module defines a mating portion corresponding to the positioning portion at a corner thereof.

3. The electronic device with a touch panel as set forth in claim 2, wherein the positioning portion is the protruding portion or the cavity.

4. The electronic device with a touch panel as set forth in claim 1, wherein the fixing plate is made of plastic material.

5. The electronic device with a touch panel as set forth in claim 1, wherein the insulating housing has a receiving cavity enclosed by a stopping sidewall, the display module and touch panel are received in the receiving cavity, the stopping sidewall has a positioning recess in an inner surface thereof, the fixing plate has a positioning protrusion extended outwardly from an outer edge thereof for being engaged with the positioning recess.

6. The electronic device with a touch panel as set forth in claim 5, wherein the touch portion is disposed in the receiving opening so that a top surface of the touch portion is flush with that of the shell.

7. The electronic device with a touch panel as set forth in claim 1, wherein the insulating housing defines an oblique mating surface, the oblique mating surface has a buckling recess, a side of the buckling recess extends outwards to form a stopping projection, the shell defines a covering sidewall for enclosing the oblique mating surface, the covering sidewall protrudes inwards to form a buckling block corresponding to the buckling recess, the buckling block is recessed to form a stopping recess for receiving the stopping projection.
